(19) United States
(12) Patent Application Publication
(10) Pub. No.: US 2025/0175977 A1
(43) Pub. Date: May 29, 2025

(54) DETERMINING A BETA OFFSET FOR UPLINK CONTROL INFORMATION ON AN UPLINK SHARED CHANNEL WITH TWO TRANSPORT BLOCKS

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US)

(21) Appl. No.: 18/840,026

(22) PCT Filed: May 7, 2022
(86) PCT No.: PCT/CN2022/091449

§ 371 Date: Aug. 20, 2024

(51) Int. Cl. H04W 72/1268; H04W 72/21; H04W 72/231; H04W 76/20

(52) U.S. Cl. CPC H04W 72/1268; H04W 72/21; H04W 72/231; H04W 76/20

(57) ABSTRACT

A method for wireless communication at a user equipment (UE) includes receiving, from a network node, signaling indicating a group of sets of beta offset values associated with one transport block (TB) and two TBs. The method also includes receiving, from the network node, downlink control information (DCI) scheduling a physical uplink shared channel (PUSCH) associated with one TB or two TBs. The method further includes transmitting uplink control information (UCI), via a quantity of resource elements (REs), on the PUSCH based on receiving the DCI or the RRC message. The quantity of REs may be determined based on a beta offset value from a set of beta offset values of the group of sets of beta offset values. The set of beta offset values may be selected based on whether the UCI is transmitted on the PUSCH associated with the one TB or the two TBs.

### FIELD OF THE DISCLOSURE

The present disclosure relates generally to wireless communications, and more specifically to determining a beta offset for uplink control channel information (UCI) transmitted on an uplink shared channel associated with two transport blocks (TBs).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

In some examples, a UE may transmit uplink control information (UCI) via an uplink shared channel, such as a physical uplink shared channel (PUSCH). A payload of the UCI may include, for example, channel state information (CSI), hybrid automatic repeat request (HARQ) information, or configured grant uplink control information (CG-UCI). A number of resource elements used for transmitting the UCI may be based on an offset value (e.g., beta offset (β_{offset}) value) selected from a set of beta offset values. Each offset value in the set of offset values may correspond to one or both of a UCI type and/or the payload of the UCI. The set of offset values may be dynamically indicated, e.g., in DCI or semi-statically configured via signaling, such as radio resource control (RRC) signaling.

### SUMMARY

In one aspect of the present disclosure, a method for wireless communication at a UE includes receiving, from a network node, signaling indicating multiple sets of beta offset values associated with one transport block (TB) and two TBs. The method further includes receiving, from the network node, downlink control information (DCI) or a radio resource control (RRC) message scheduling a physical uplink shared channel (PUSCH) associated with one TB or two TBs. The method still further includes transmitting uplink control information (UCI), via a quantity of resource elements (REs), on the PUSCH associated with the one TB or the two TBs based on receiving the DCI or the RRC message. The quantity of REs may be determined based on a beta offset value from a set of beta offset values of the multiple sets of beta offset values. The set of beta offset values may be selected from the multiple sets of beta offset values based on whether the UCI is transmitted on the PUSCH associated with the one TB or the two TBs.

Another aspect of the present disclosure is directed to an apparatus including means for receiving, from a network node, signaling indicating multiple sets of beta offset values associated with one TB and two TBs. The apparatus further includes means for receiving, from the network node, DCI or an RRC message scheduling a PUSCH associated with one TB or two TBs. The apparatus still further includes means for transmitting UCI, via a quantity of REs, on the PUSCH associated with the one TB or the two TBs based on receiving the DCI or the RRC message. The quantity of REs may be determined based on a beta offset value from a set of beta offset values of the multiple sets of beta offset values. The set of beta offset values may be selected from the multiple sets of beta offset values based on whether the UCI is transmitted on the PUSCH associated with the one TB or the two TBs.

In another aspect of the present disclosure, a non-transitory computer-readable medium with non-transitory program code recorded thereon is disclosed. The program code is executed by a processor and includes program code to receive, from a network node, signaling indicating multiple sets of beta offset values associated with one TB and two TBs. The program code further includes program code to receive, from the network node, DCI or an RRC message scheduling a PUSCH associated with one TB or two TBs. The program code still further includes program code to transmit UCI, via a quantity of REs, on the PUSCH associated with the one TB or the two TBs based on receiving the DCI or the RRC message. The quantity of REs may be determined based on a beta offset value from a set of beta offset values of the multiple sets of beta offset values. The set of beta offset values may be selected from the multiple sets of beta offset values based on whether the UCI is transmitted on the PUSCH associated with the one TB or the two TBs.

Another aspect of the present disclosure is directed to an apparatus comprising a processor, and a memory coupled with the processor and storing instructions operable, when executed by the processor, to cause the apparatus to receive, from a network node, signaling indicating multiple sets of beta offset values associated with one TB and two TBs. Execution of the instructions also cause the apparatus to receive, from the network node, DCI or an RRC message scheduling a PUSCH associated with one TB or two TBs. Execution of the instructions further cause the apparatus to transmit UCI, via a quantity of REs, on the PUSCH associated with the one TB or the two TBs based on receiving the DCI or the RRC message. The quantity of REs may be determined based on a beta offset value from a set of beta offset values of the multiple sets of beta offset values. The set of beta offset values may be selected from the multiple sets of beta offset values based on whether the UCI is transmitted on the PUSCH associated with the one TB or the two TBs.

In one aspect of the present disclosure, a method for wireless communication at a UE includes receiving, from a network node, signaling indicating multiple of sets of beta offset values associated with two TBs. The method further includes receiving, from the network node, DCI or an RRC message scheduling a PUSCH associated with two TBs. The method still further includes transmitting first uplink UCI, via a quantity of first REs, on the PUSCH associated within a first TB of the two TBs based on receiving the DCI or the RRC message. The quantity of first REs may be determined based on a beta offset value from a set of beta offset values of the multiple sets of beta offset values. The set of beta offset values may be selected based on whether second UCI is multiplexed on second REs within a second TB of the two TBs, the first REs corresponding to the second REs.

Another aspect of the present disclosure is directed to an apparatus including means for receiving, from a network node, signaling indicating multiple of sets of beta offset values associated with two TBs. The apparatus further includes means for receiving, from the network node, DCI or an RRC message scheduling a PUSCH associated with two TBs. The apparatus still further includes means for transmitting first uplink UCI, via a quantity of first REs, on the PUSCH associated within a first TB of the two TBs based on receiving the DCI or the RRC message. The quantity of first REs may be determined based on a beta offset value from a set of beta offset values of the multiple sets of beta offset values. The set of beta offset values may be selected based on whether second UCI is multiplexed on second REs within a second TB of the two TBs, the first REs corresponding to the second REs.

In another aspect of the present disclosure, a non-transitory computer-readable medium with non-transitory program code recorded thereon is disclosed. The program code is executed by a processor and includes program code to receive, from a network node, signaling indicating multiple of sets of beta offset values associated with two TBs. The program code further includes program code to receive, from the network node, DCI or an RRC message scheduling a PUSCH associated with two TBs. The program code still further includes program code to transmit first uplink UCI, via a quantity of first REs, on the PUSCH associated within a first TB of the two TBs based on receiving the DCI or the RRC message. The quantity of first REs may be determined based on a beta offset value from a set of beta offset values of the multiple sets of beta offset values. The set of beta offset values may be selected based on whether second UCI is multiplexed on second REs within a second TB of the two TBs, the first REs corresponding to the second REs.

Another aspect of the present disclosure is directed to an apparatus comprising a processor, and a memory coupled with the processor and storing instructions operable, when executed by the processor, to cause the apparatus to receive, from a network node, signaling indicating multiple of sets of beta offset values associated with two TBs. Execution of the instructions further cause the apparatus to receive, from the network node, DCI or an RRC message scheduling a PUSCH associated with two TBs. Execution of the instructions also cause the apparatus to transmit first uplink UCI, via a quantity of first REs, on the PUSCH associated within a first TB of the two TBs based on receiving the DCI or the RRC message. The quantity of first REs may be determined based on a beta offset value from a set of beta offset values of the multiple sets of beta offset values. The set of beta offset values may be selected based on whether second UCI is multiplexed on second REs within a second TB of the two TBs, the first REs corresponding to the second REs.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4A is a timing diagram illustrating an example of configuring multiple sets of beta offset values associated with one transport block (TB) and two TBs, in accordance with various aspects of the present disclosure.

FIG. 4B is a block diagram illustrating an example of a physical uplink shared channel (PUSCH) with one TB and a PUSCH with two TBs.

FIG. 5A is a timing diagram illustrating an example of configuring multiple sets of beta offset values associated with two TBs, in accordance with various aspects of the present disclosure.

FIG. 5B is a block diagram illustrating examples of PUSCHs with two TBs, in accordance with various aspects of the present disclosure.

FIG. 6 is a flow diagram illustrating an example process performed, for example, by a user equipment (UE), in accordance with various aspects of the present disclosure.

FIG. 7 is a flow diagram illustrating an example process performed, for example, by a UE, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

In some examples, a user equipment (UE) may transmit uplink control information (UCI) via an uplink shared channel, such as a physical uplink shared channel (PUSCH). A payload of the UCI may include, for example, channel state information (CSI), hybrid automatic repeat request (HARQ) information, or configured grant uplink control information (CG-UCI). A number of resource elements used for transmitting the UCI may be based on an offset value (e.g., beta offset (β_{offset}) value) selected from a set of offset values. Each beta offset value in the set of beta offset values may correspond to one or both of a UCI type and/or the payload of the UCI. The set of beta offset values may be dynamically indicated, e.g., in DCI or semi-statically configured via signaling, such as radio resource control (RRC) signaling.

Some wireless communication systems may support multi-layer uplink transmissions. In such systems, two codewords may be supported for an uplink transmission with more than one layer. For example, a physical uplink shared channel (PUSCH) may be scheduled with two transport blocks (TB), in which each TB is associated with different transmission parameters, such as a modulation and coding scheme (MCS), a new data indicator (NDI), a redundancy version (RV), and/or other parameters. In some examples, a number of coded modulation symbols, per layer, for UCI transmitted on a PUSCH with a single TB may be different than a number of coded modulation symbols, per layer, for UCI transmitted on a PUSCH with multiple TBs. In such examples, a single set of beta offset values may not be used for both the PUSCH with one TB and the PUSCH with multiple TBs. Various aspects of the present disclosure are directed to configuring one or more sets of beta offset values for a PUSCH scheduled with multiple TBs.

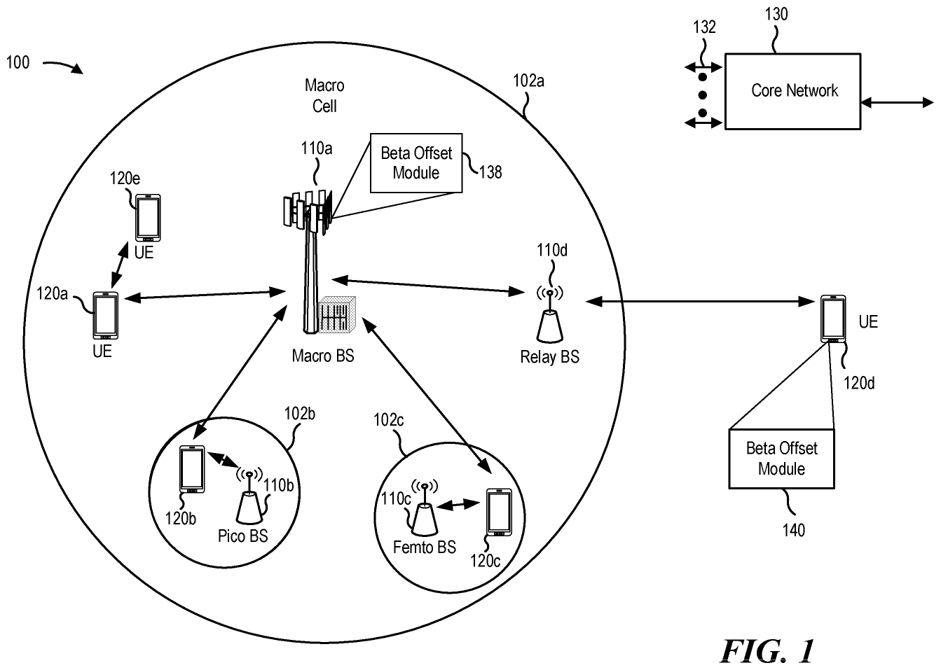

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

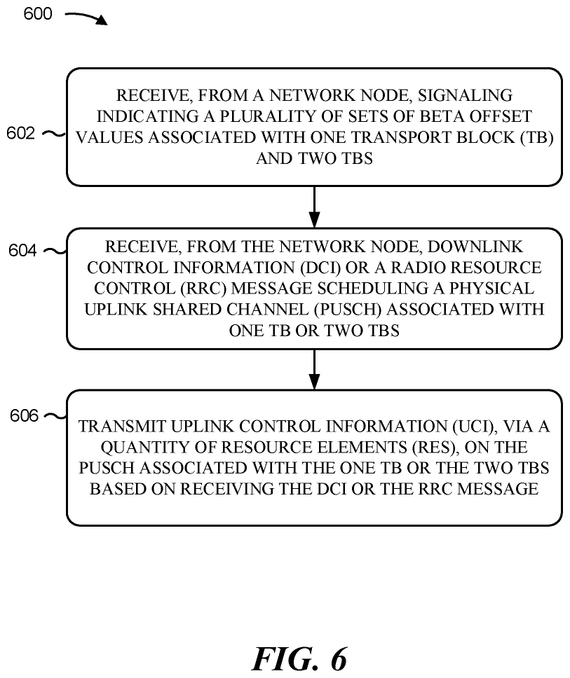

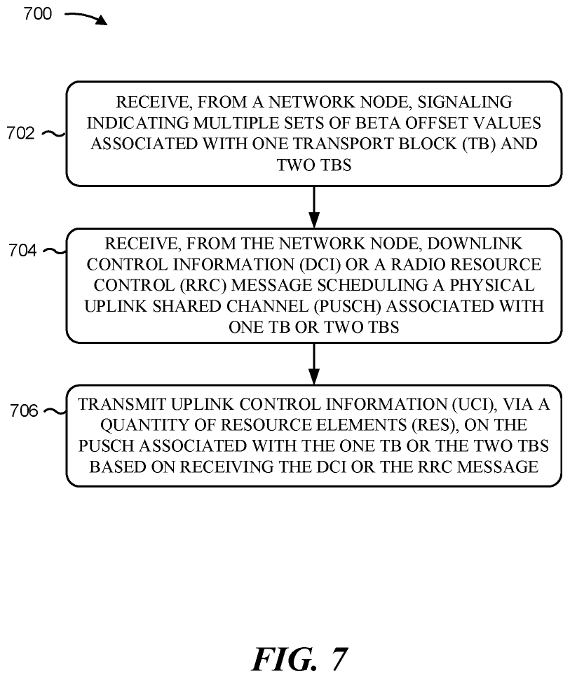

The UEs 120 may include a beta offset module 140. For brevity, only one UE 120d is shown as including the beta offset module 140. The beta offset module 140 may be configured to perform the steps of the process 600 and/or the process 700 described with reference to FIGS. 6 and 7, respectively.

The core network 130 or the base stations 110 may include a beta offset module 138 for transmitting signaling indicating multiple of sets of beta offset values associated with two TBs; transmitting DCI or an RRC message scheduling a PUSCH associated with two TBs; and receiving transmitting first uplink UCI, via a quantity of first REs, on the PUSCH associated within a first TB of the two TBs based on transmitting the DCI or the RRC message. In some examples, the quantity of first REs may be based on a beta offset value from a set of beta offset values of the multiple sets of beta offset values. The set of beta offset values may be selected based on whether second UCI is multiplexed on second REs within a second TB of the two TBs. The first REs may correspond to the second REs.

Additionally, or alternatively, the beta offset module 138 may transmit signaling indicating multiple sets of beta offset values associated with one TB and two TBs; transmit DCI or an RRC message scheduling a PUSCH associated with one TB or two TBs; and receive UCI, via a quantity of REs, on the PUSCH associated with the one TB or the two TBs based on transmitting the DCI or the RRC message. The quantity of REs may be based on a beta offset value from a set of beta offset values of the multiple sets of beta offset values. The set of beta offset values selected from the multiple sets of beta offset values may be based on whether the UCI is received on the PUSCH associated with the one TB or the two TBs.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

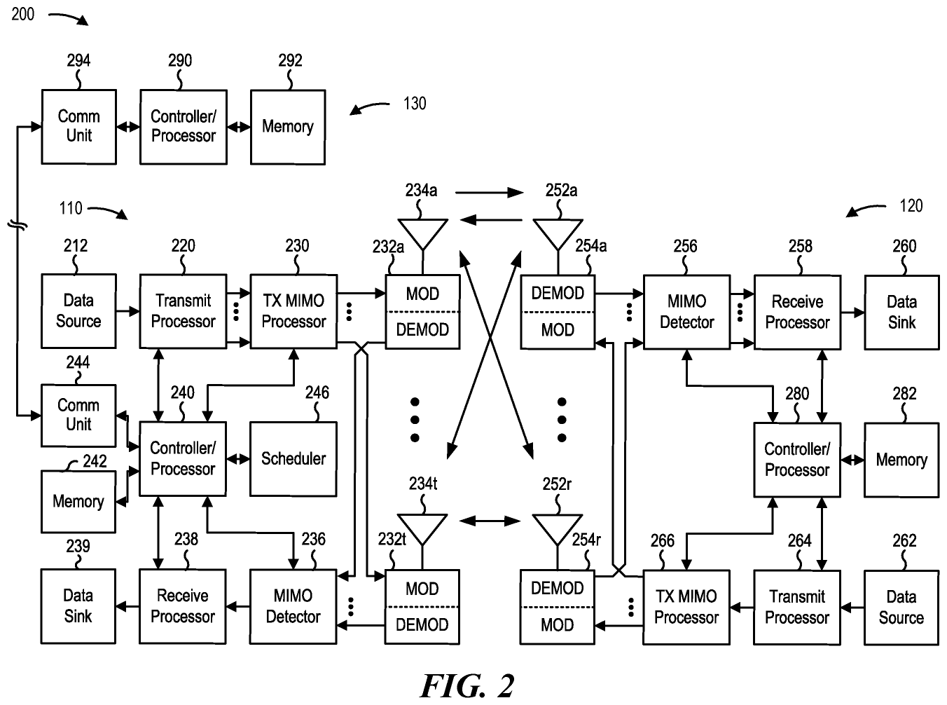

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with configuring beta offset values for a PUSCH with multiple TBs as described in more detail elsewhere. For example, the controller/processor 240 of the base station 110, the controller/processor 280 of the UE 120, and/or any other component(s) of FIG. 2 may perform or direct operations of, for example, the processes of FIGS. 6 and 7 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for receiving, from a network node, signaling indicating multiple of sets of beta offset values associated with two TBs; means for receiving, from the network node, DCI or an RRC message scheduling a PUSCH associated with two TBs; and means for transmitting first uplink UCI, via a quantity of first REs, on the PUSCH associated within a first TB of the two TBs based on receiving the DCI or the RRC message. Additionally, or alternatively, the UE 120 may include means for receiving, from a network node, signaling indicating multiple sets of beta offset values associated with one TB and two TBs; means for receiving, from the network node, DCI or an RRC message scheduling a PUSCH associated with one TB or two TBs; and means for transmitting UCI, via a quantity of REs, on the PUSCH associated with the one TB or the two TBs based on receiving the DCI or the RRC message. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

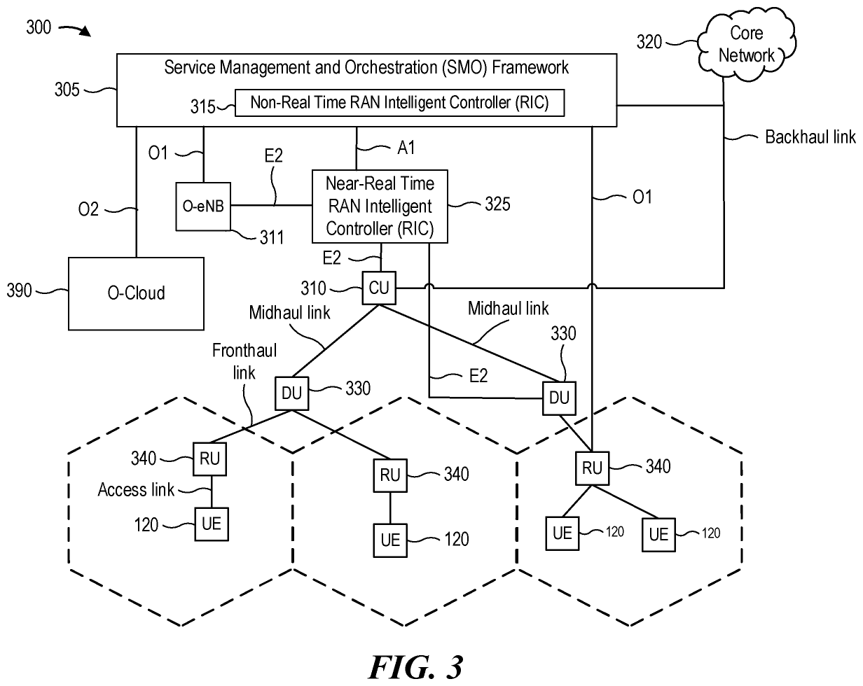

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via O1) or via creation of RAN management policies (such as A1 policies).

In some examples, a UE may transmit uplink control information (UCI) via an uplink shared channel, such as a physical uplink shared channel (PUSCH). A payload of the UCI may include, for example, channel state information (CSI), hybrid automatic repeat request (HARQ) information or configured grant uplink control information (CG-UCI). A number of resource elements used for transmitting the UCI may be based on a beta offset value (e.g., beta offset (β_{offset}) value) selected from a set of offset values. Each beta offset value in the set of beta offset values may correspond to one or both of a UCI type and/or the payload of the UCI. The set of beta offset values may be dynamically indicated, e.g., in DCI or semi-statically configured via signaling, such as radio resource control (RRC) signaling.

In some examples, a semi-static indication of a set of beta offset values may be applied with fallback downlink control information (DCI) for an uplink assignment. A same set of beta offset values with fallback DCI may be reused for HARQ feedback and CSI. In some examples, a set of beta offset values associated with a semi-static indication may be different from a set of beta offset values associated with a dynamic indication. The semi-static indication may be a default configuration for non-fall back DCI for a UL assignment.

As discussed, one or more sets of offset values (e.g., beta offset values) may be configured by RRC signaling. Each set of beta offset values may include multiple entries (e.g., beta offset values), each beta offset value may correspond to a UCI type and/or a UCI payload. In some examples, an index to a set of beta offset values may be dynamically indicated. As an example, a downlink control channel, such as a physical downlink control channel (PDCCH), may transmit a message that dynamically indicates the index to the set of beta offset values. As another example, for fallback DCI, if the dynamic indication is configured via RRC signaling, the first set of beta offset values may be applied.

As discussed, a set of beta offset values may include multiple beta offset values. In some examples, the multiple beta offset values may include a first beta offset index value of HARQ feedback, a second beta offset index value for CSI part one, and a third beta offset index value for CSI part two. The values for the first, second, and third beta offset index values may be based on values defined in the 3GPP communication standards, such as 3GPP 38.213.

Some wireless communication systems may support multi-layer uplink transmissions. The multi-layer uplink transmissions may be used to improve uplink throughput and/or reliability via simultaneous multi-panel uplink transmissions. In such systems, two codewords may be supported for an uplink transmission with more than one layer. For example, a physical uplink shared channel (PUSCH) may be scheduled with two transport blocks (TB), in which each TB is associated with different transmission parameters, such as a modulation and coding scheme (MCS), a new data indicator (NDI), a redundancy version (RV), and/or other parameters. In some examples, a number of coded modulation symbols, per layer, for a UCI transmitted on a PUSCH with a single TB may be different than a number of coded modulation symbols, per layer, for a UCI transmitted on a PUSCH with multiple TBs. In such examples, a single set of beta offset values may not be used for both the PUSCH with one TB and the PUSCH with multiple TBs. Various aspects of the present disclosure are directed to configuring one or more sets of beta offset values for a PUSCH scheduled with multiple TBs.

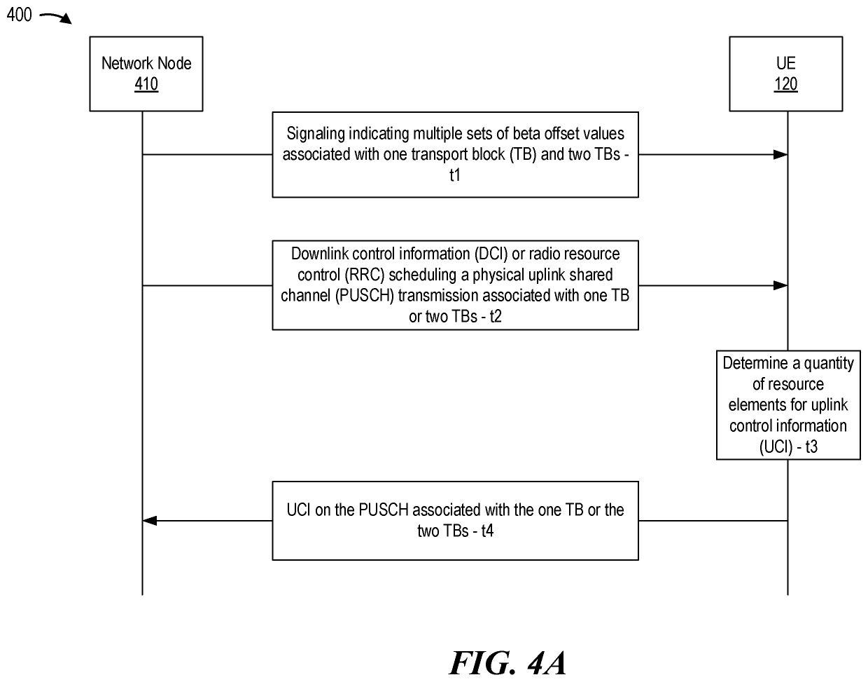

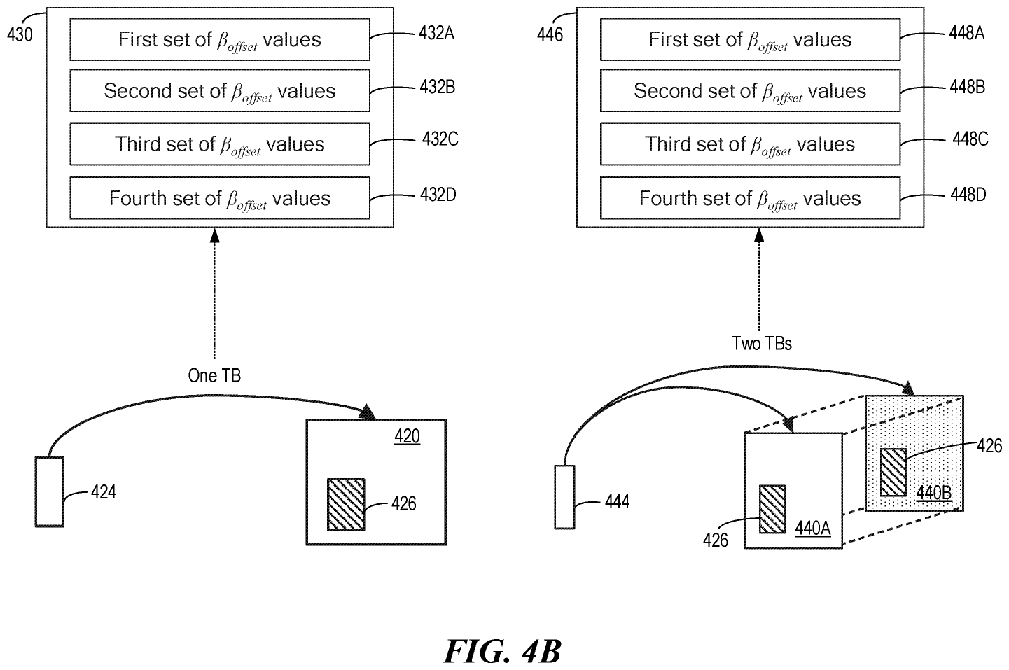

FIG. 4A is a timing diagram illustrating an example 400 of configuring multiple sets of beta offset values associated with one TB and two TBs, in accordance with various aspects of the present disclosure. As shown in the example 400, a UE 120 may communicate with a network node 410, such as a base station 110 as described with reference to FIGS. 1 and 2, or a CU 310, DU 330, or RU 340 as described with reference to FIG. 3. As shown in FIG. 4A, at time t1, the UE 120 may receive signaling indicating multiple sets of beta offset values associated with one TB and two TBs. As discussed, the signaling may be RRC signaling. In some implementations, the multiple sets of beta offset values indicated via the signaling at time t1 may include a first set of beta offset values and a second set of beta offset values. In such implementations, the first set of beta offset values may be associated with a UCI transmission on a PUSCH associated with one TB. Additionally, the second set of beta offset values may be associated with a UCI transmission on a PUSCH associated with two TBs. Furthermore, in such implementations, the signaling indicating the multiple sets of beta offset values may be a semi-static indication.

In some other implementations, the multiple sets of beta offset values indicated via the signaling at time t1 may include a first group of sets of beta offset values and a second group of sets of beta offset values. In such implementations, the first group of sets of beta offset values may be associated with the UCI transmission on the PUSCH associated with one TB. Additionally, the second group of sets of beta offset values may be associated with the UCI transmission on the PUSCH associated with two TBs. In some examples, each set of beta offset values in the first group and the second group may be associated with a different codepoint. In some such examples, a set of beta offset values is selected from the first group or the second group of sets of beta offsets based on a codepoint indicated via DCI, such as the DCI that schedules a PUSCH transmission.

As shown in the example 400 of FIG. 4A, at time t2, the network node 410 may transmit DCI or RRC message scheduling of a PUSCH transmission with one TB or two TBs. At time t3, the UE 120 may determine a quantity of resource elements (REs) to allocate for uplink control information (UCI). The number of REs may be based on a beta offset value from a set of beta offset values selected from the multiple sets of beta offset values configured via the signaling received at time t1. The set of beta offset values may be selected based on whether the UCI is transmitted on the PUSCH associated with the one TB or the two TBs. At time t4, after determining the number of REs, the UE 120 may transmit the UCI on the PUSCH associated with the one TB or the two TBs.

As discussed with reference to FIG. 4A, a UE 120 may receive signaling indicating multiple sets of beta offset values associated with one TB and two TBs. FIG. 4B is a block diagram illustrating an example of a PUSCH with one TB 420 and a PUSCH with two TBs 440A and 440B. As shown in the example of FIG. 4B, DCI 424 may schedule the PUSCH with the single TB 420. In this example, the UCI 426 may be transmitted on REs within the single TB 420. In some examples, UCI 426 that is transmitted on the PUSCH with the single TB 420 may be associated with a first set of beta offset values from multiple sets of beta offset values indicated via downlink signaling. In some other examples, UCI 426 that is transmitted on the PUSCH with the single TB 420 may be associated with a first group of sets of beta offset values 430. As shown in the example of FIG. 4B, the first group of sets of beta offset values 430 includes a first set of beta offset values 432A, a second set of beta offset values 432B, a third set of beta offset values 432C, and a fourth set of beta offset values 432D. The first group of sets of beta offset values 430 is not limited to four sets of beta offset values; additional or fewer sets may be configured. As discussed, in some examples, each set of beta offset values 432A, 432B, 432C, and 432D may be associated with a different codepoint, such that one of the sets of beta offset values 432A, 432B, 432C, and 432D may be selected based on a codepoint indicated via downlink signaling, such as DCI.

As shown in the example of FIG. 4B, the DCI 444 may schedule the PUSCH with the two TBs 440A and 440B. In the example of FIG. 4B, the UCI 426 is transmitted on REs within both of the TBs 440A and 440B. In other examples (not shown in FIG. 4B), the UCI 426 may be transmitted on REs within one of the two TBs 440A and 440B. In some examples, UCI 426 that is transmitted on the PUSCH with the two TBs 440A and 440B may be associated with a second set of beta offset values from multiple sets of beta offset values indicated via downlink signaling. The second set of beta offset values may be different than the first set of beta offset values associated with the PUSCH with a single TB 420. In some other examples, UCI 426 that is transmitted on the PUSCH with the two TBs 440A and 440B may be associated with a second group of sets of beta offset values 446. As shown in the example of FIG. 4B, the second group of sets of beta offset values 446 includes a first set of beta offset values 448A, a second set of beta offset values 448B, a third set of beta offset values 448C, and a fourth set of beta offset values 448D. The second group of sets of beta offset values 446 is not limited to four sets of beta offset values; additional or fewer sets may be configured. As discussed, in some examples, each set of beta offset values 448A, 448B, 448C, and 448D may be associated with a different codepoint, such that one of the sets of beta offset values 448A, 448B, 448C, and 448D may be selected based on a codepoint indicated via downlink signaling, such as DCI. The second group of sets of beta offset values 446 associated with the PUSCH with two TBs 440A and 440B may be different than the first group of sets of beta offset values 430 associated with the PUSCH with one TB 420.

In some examples, first UCI may be allocated to REs within a first TB of a PUSCH with two TBs and second UCI may be multiplexed on REs within a second TB of the PUSCH with two TBs. In some such examples, the REs allocated to the first UCI and the second UCI may be the same REs (e.g., corresponding REs on different TBs). In some implementations, a UE may select a set of beta offset values from multiple sets of beta offset values based on whether two UCIs are multiplexed on the same REs of different TBs.

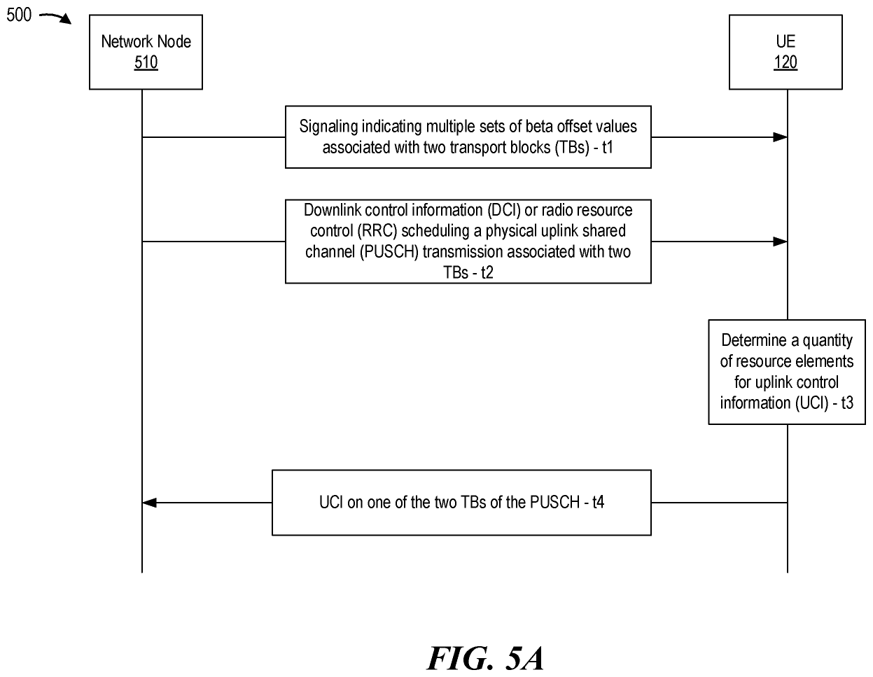

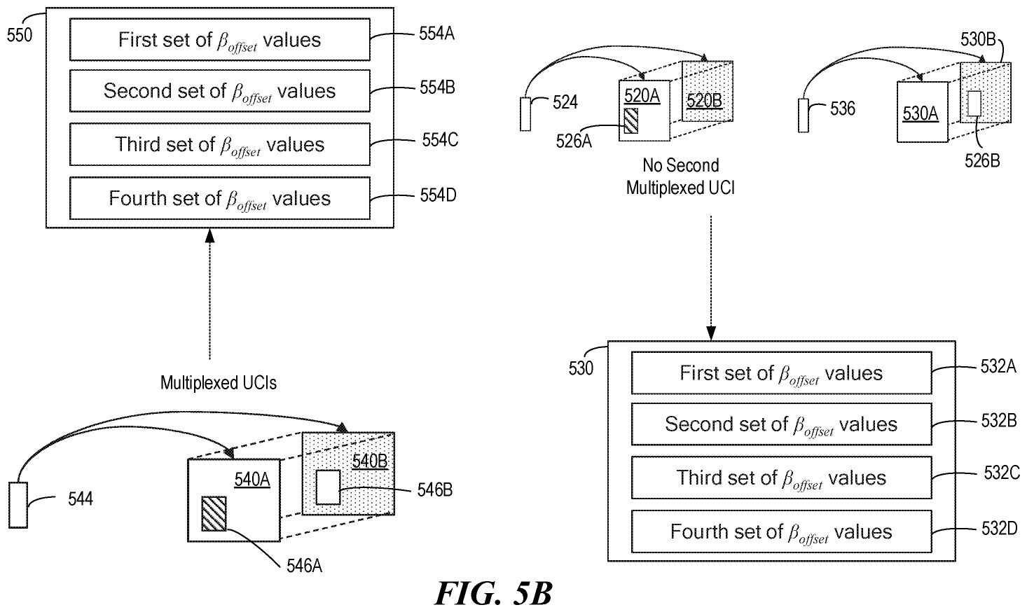

FIG. 5A is a timing diagram illustrating an example 500 of configuring multiple sets of beta offset values associated with two TBs, in accordance with various aspects of the present disclosure. As shown in the example 500, a UE 120 may communicate with a network node 510, such as a base station 110 as described with reference to FIGS. 1 and 2, or a CU 310, DU 330, or RU 340 as described with reference to FIG. 3. As shown in FIG. 5A, at time t1, the UE 120 may receive signaling, such as RRC signaling, indicating multiple sets of beta offset values associated with two TBs. The two TBs may be associated with a single PUSCH. In some examples, first UCI may be allocated to REs within a first TB of the two TBs. In such examples, second UCI may be multiplexed on second REs within a second TB of the two TBs. In some such examples, the first REs may correspond to the second REs. In some implementations, the multiple sets of beta offset values indicated via the signaling at time t1 may include a first set of beta offset values and a second set of beta offset values. In such implementations, the first set of beta offset values may be associated with the first UCI transmission on the first TB of the two TBs, in which other UCI (e.g., the second UCI) is not multiplexed on the second REs of a second TB of the two TBs. Additionally, the second set of beta offset values may be associated with the first UCI transmission on the first TB of the two TBs, in which the second UCI is multiplexed on the second REs of the second TB of the two TBs. Furthermore, in such implementations, the signaling indicating the multiple sets of beta offset values may be a semi-static indication.

In some other implementations, the multiple sets of beta offset values indicated via the signaling at time t1 may include a first group of sets of beta offset values and a second group of sets of beta offset values. In such implementations, the first group of sets of beta offset values may be associated with the first UCI transmission on the first TB of the two TBs, in which other UCI (e.g., the second UCI) is not multiplexed on the second REs of a second TB of the two TBs. Additionally, the second group of sets of beta offset values may be associated with the first UCI transmission on the first TB of the two TBs, in which the second UCI is multiplexed on the second REs of the second TB of the two TBs. In some examples, each set of beta offset values in the first group and the second group of sets of beta offsets may be associated with a different codepoint. In some such examples, a set of beta offset values is selected from the first group or the second group of sets of beta offsets based on a codepoint indicated via DCI, such as the DCI that schedules a PUSCH transmission.

As shown in the example 500 of FIG. 5A, at time t2, the network node 510 may transmit DCI or an RRC message for scheduling a PUSCH transmission with the two TBs. Additionally, at time t3, the UE 120 may determine a quantity of REs to allocate for the UCI transmitted via the PUSCH associated with two TBs. The number of RE allocated for transmitting the UCI may be determined based on a beta offset value from a set of beta offset values selected from the multiple sets of beta offset values configured via the signaling received at time t1. As discussed above, the set of beta offset values may be selected based on whether second UCI and the first UCI are multiplexed on the same REs within two TBs associated with the same PUSCH. At time t4, after determining the number of REs, the UE 120 may transmit the first UCI on one of the two TBs of the PUSCH scheduled via the DCI at time t2. In some examples (not shown in FIG. 5A), at time t4, the UE 120 may also transmit the second UCI on another one of the two TBs of the PUSCH. In this example, the first UCI and the second UCI may be multiplexed on the same REs of the two TBs.

As discussed with reference to FIG. 5A, a UE 120 may receive signaling indicating multiple sets of beta offset values associated with two TBs. FIG. 5B is a block diagram illustrating examples of PUSCHs with two TBs, in accordance with various aspects of the present disclosure. As shown in the example of FIG. 5B, a first DCI 524 may schedule a first PUSCH with the two TBs 520A and 520B. In this example, first UCI 526A may be transmitted on REs within the first TB 520A. In this example, a payload of the first UCI 526A may be HARQ feedback. Thus, a number of REs allocated to the first UCI 526A may be based on a HARQ feedback beta offset value (β_{offset}^{HARQ-ACK}) in a set of beta offset values selected from multiple beta offset values indicated via signaling, such as RRC signaling. Additionally, as shown in FIG. 5B, second UCI 526B may be transmitted on REs within a second TB 530B associated with a second PUSCH scheduled via second DCI 536. The second PUSCH may be associated with two TBs 530A and 530B. In this example, a payload of the second UCI 526B may be CSI part two. Thus, a number of REs allocated to the second UCI 526B may be based on a CSI part two beta offset value (β_{offset}^{CSI-2}) in a set of beta offset values selected from the multiple beta offset values.

In the example of FIG. 5B, the first UCI 526A and other UCI are not multiplexed on the same REs of different TBs 520A and 520B associated with the same PUSCH. Therefore, the set of beta offset values selected from the multiple sets of beta offset values may be a first set of beta offset values that is applied when two UCIs are not multiplexed on the same REs of different TBs associated with the same PUSCH. Alternatively, a first group of sets of beta offset values 530 may be configured for the first UCI 526A, when the first UCI 526A and other UCI are not multiplexed on the same REs of different TBs 520A and 520B associated with the same PUSCH. As shown in the example of FIG. 5B, the first group of sets of beta offset values 530 includes a first set of beta offset values 532A, a second set of beta offset values 532B, a third set of beta offset values 532C, and a fourth set of beta offset values 532D. The first group of sets of beta offset values 530 is not limited to four sets of beta offset values; additional or fewer sets may be configured. As discussed, in some examples, each set of beta offset values 532A, 532B, 532C, and 532D may be associated with a different codepoint, such that one of the sets of beta offset values 532A, 532B, 532C, and 532D may be selected based on a codepoint indicated via downlink signaling, such as DCI.

Additionally, as shown in the example of FIG. 5B, a third DCI 544 may schedule a third PUSCH with two TBs 540A and 540B. In this example, third UCI 546A may be transmitted on REs within the first TB 540A. In this example, a payload of the third UCI 546A may be HARQ feedback. Thus, a number of REs allocated to the third UCI 546A may be based on a HARQ feedback beta offset value (β_{offset}^{HARQ-ACK}) in a set of beta offset values selected from multiple beta offset values indicated via signaling, such as RRC signaling. Additionally, as shown in FIG. 5B, fourth UCI 546B may be transmitted on REs within a second TB 540B associated with the third PUSCH scheduled via the third DCI 544. In this example, a payload of the fourth UCI 546B may be CSI part two. Thus, a number of REs allocated to the fourth UCI 546B may be based on a CSI part two beta offset value (β_{offset}^{CSI-2}) in a set of beta offset values selected from the multiple beta offset values.

In the example of FIG. 5B, the third UCI 546A and the fourth UCI 546B are multiplexed on the same REs of different TBs 540A and 540B associated with the same PUSCH. Therefore, the set of beta offset values selected from the multiple sets of beta offset values may be a second set of beta offset values that is applied when two UCIs are multiplexed on the same REs of different TBs associated with the same PUSCH. Alternatively, a second group of sets of beta offset values 550 may be configured for the third UCI 546A, when the third UCI 546A and the fourth UCI 546B are multiplexed on the same REs of different TBs 540A and 540B associated with the same PUSCH. As shown in the example of FIG. 5B, the second group of sets of beta offset values 550 includes a first set of beta offset values 554A, a second set of beta offset values 554B, a third set of beta offset values 554C, and a fourth set of beta offset values 554D. The second group of sets of beta offset values 550 is not limited to four sets of beta offset values; additional or fewer sets may be configured. As discussed, in some examples, each set of beta offset values 554A, 554B, 554C, and 554D may be associated with a different codepoint, such that one of the sets of beta offset values 554A, 554B, 554C, and 554D may be selected based on a codepoint indicated via downlink signaling, such as DCI. The first group of sets of beta offset values 530 and the second group of sets of beta offset values 550 may be configured via multiple sets of beta offset values indicated via signaling, such as RRC signaling.

FIG. 6 is a flow diagram illustrating an example process 600 performed, for example, by a UE, in accordance with various aspects of the present disclosure. The example process 600 is an example of allocating REs for UCI based on a set of beta offset values selected from multiple sets of beta offset values associated with one TB and two TBs. The process 600 may be performed at a UE, such as a UE 120 described with reference to FIGS. 1, 2, and 3. As shown in FIG. 6, the process 600 begins at block 602 by receiving, from a network node, signaling indicating multiple sets of beta offset values associated with one TB and two TBs. At block 604, the process 600 receives, from the network node, DCI or an RRC message scheduling a physical uplink shared channel (PUSCH) associated with one TB or two TBs. In some examples, the PUSCH may be a configured grant (CG) PUSCH (CG-PUSCH). At block 606, the process 600 transmits UCI, via a quantity of REs, on the PUSCH associated with the one TB or the two TBs based on receiving the DCI or the RRC message. In some examples, the quantity of REs may be determined based on a beta offset value from a set of beta offset values of the multiple sets of beta offset values. In such examples, the set of beta offset values may be selected from the multiple sets of beta offset values based on whether the UCI is transmitted on the PUSCH associated with the one TB or the two TBs.

FIG. 7 is a flow diagram illustrating an example process 700 performed, for example, by a UE, in accordance with various aspects of the present disclosure. The example process 700 is an example of allocating REs for UCI based on a beta offset value selected from multiple sets of beta offset values associated with two TBs. The process 700 may be performed at a UE, such as a UE 120 described with reference to FIGS. 1, 2, and 3. As shown in FIG. 7, the process 700 begins at block 702 by receiving, from a network node, signaling indicating multiple sets of beta offset values associated with two TBs. At block 704, the process 700 receives, from the network node, DCI or an RRC message scheduling a PUSCH associated with two TBs. In some examples, the PUSCH may be a CG-PUSCH. At block 706, the process 700 transmits first uplink UCI, via a quantity of first REs, on the PUSCH associated within a first TB of the two TBs based on receiving the DCI or the RRC message. The quantity of first REs may be determined based on a beta offset value from a set of beta offset values of the multiple sets of beta offset values. The set of beta offset values may be selected based on whether second UCI is multiplexed on second REs within a second TB of the two TBs. The first REs may correspond to the second REs.

Implementation examples are described in the following numbered clauses:
Clause 1. A method for wireless communication at a user equipment (UE), comprising: receiving, from a network node, signaling indicating a plurality of sets of beta offset values associated with one transport block (TB) and two TBs; receiving, from the network node, downlink control information (DCI) or a radio resource control (RRC) message scheduling a physical uplink shared channel (PUSCH) associated with one TB or two TBs; and transmitting uplink control information (UCI), via a quantity of resource elements (REs), on the PUSCH associated with the one TB or the two TBs based on receiving the DCI or the RRC message, the quantity of REs determined based on a beta offset value from a set of beta offset values of the plurality of sets of beta offset values, the set of beta offset values selected from the plurality of sets of beta offset values based on whether the UCI is transmitted on the PUSCH associated with the one TB or the two TBs.
Clause 2. The method of Clause 1, in which the signaling indicating the plurality of sets of beta offset values is a semi-static indication.
Clause 3. The method of any one of Clauses 1-2, in which: the plurality of sets of beta offset values includes a first set of beta offset values and a second set of beta offset values; the set of beta offset values corresponds to the first set of beta offset values based on the UCI being transmitted on the PUSCH associated with the one TB; and the set of beta offset values corresponds to the second set of beta offset values based on the UCI being transmitted on the PUSCH associated with the two TBs.
Clause 4. The method of Clause 1, in which: the plurality of sets of beta offset values includes a first group of sets of beta offset values and a second group of sets of beta offset values; the set of beta offset values corresponds to one set of beta offset values from the first group of sets of beta offset values based on the UCI being transmitted on the PUSCH associated with the one TB; and the set of beta offset values corresponds to one set of beta offset values from the second group of sets of beta offset values based on the UCI being transmitted on the PUSCH with the two TBs.
Clause 5. The method of Clause 4, in which: each set of beta offset values in the first group of sets of beta offset values and the second group of sets of beta offset values is associated with a different codepoint; and the set of beta offset values corresponds to a codepoint indicated via the DCI.
Clause 6. The method of any one of Clauses 1-5, in which: each set of beta offset values of the plurality of sets of beta offset values includes multiple beta offset values; and each beta offset value of the multiple beta offset values corresponds to one or both of a UCI type or a payload.
Clause 7. The method of any one of Clauses 1-6, in which the signaling is RRC signaling.
Clause 8. The method of any one of Clauses 1-7, in which the UCI includes hybrid automatic repeat request (HARQ) feedback, channel state information (CSI), or configured grant uplink control information (CG-UCI).
Clause 9. A method for wireless communication at a user equipment (UE), comprising: receiving, from a network node, signaling indicating a plurality of sets of beta offset values associated with two transport blocks (TBs); receiving, from the network node, downlink control information (DCI) or a radio resource control (RRC) message scheduling a physical uplink shared channel (PUSCH) associated with two TBs; and transmitting first uplink control information (UCI), via a quantity of first resource elements (REs), on the PUSCH associated within a first TB of the two TBs based on receiving the DCI or the RRC message, the quantity of first REs determined based on a beta offset value from a set of beta offset values of the plurality of sets of beta offset values, the set of beta offset values selected based on whether second UCI is multiplexed on second REs within a second TB of the two TBs, the first REs corresponding to the second REs.
Clause 10. The method of Clause 9, in which the signaling indicating the plurality of sets of beta offset values is a semi-static indication.
Clause 11. The method of any one of Clauses 9-10, in which: the plurality of sets of beta offset values includes a first set of beta offset values and a second set of beta offset values; the set of beta offset values corresponds to the first set of beta offset values based on no UCI being multiplexed on the second REs; and the set of beta offset values corresponds to the second set of beta offset values based on the second UCI being multiplexed on the second REs.
Clause 12. The method of Clause 9, in which: the plurality of sets of beta offset values includes a first group of sets of beta offset values and a second group of sets of beta offset values; the set of beta offset values corresponds to one set of beta offset values from the first group of sets of beta offset values based on no UCI being multiplexed on the second REs; and the set of beta offset values corresponds to one set of beta offset values from the second group of sets of beta offset values based on the second UCI being multiplexed on the second REs.
Clause 13. The method of Clause 12, in which: each respective set of beta offset values in the first group of sets of beta offset values and the second group of sets of beta offset values is associated with a different codepoint; and the set of beta offset values corresponds to a codepoint indicated via the DCI.
Clause 14. The method of any one of Clauses 9-13, in which: each set of beta offset values of the plurality of sets of beta offset values includes multiple beta offset values; and each beta offset value of the multiple beta offset values corresponds to one or both of a UCI type or a payload.
Clause 15. The method of any one of Clauses 9-14, in which the signaling is RRC signaling.
Clause 16. A UE comprising a processor, memory coupled with the processor, and instructions stored in the memory and operable, when executed by the processor to cause the UE to perform any one of Clauses 1 through 8.
Clause 17. An apparatus configured for wireless communications comprising at least one means for performing any one of Clauses 1 through 8.
Clause 18. A computer program comprising code for causing an apparatus to perform any one of Clauses 1 through 8.
Clause 19. A UE comprising a processor, memory coupled with the processor, and instructions stored in the memory and operable, when executed by the processor to cause the UE to perform any one of Clauses 9 through 15.
Clause 20. An apparatus configured for wireless communications comprising at least one means for performing any one of Clauses 9 through 15.
Clause 21. A computer program comprising code for causing an apparatus to perform any one of Clauses 9 through 15.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code-it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication at a user equipment (UE), comprising:
receiving, from a network node, signaling indicating a plurality of sets of beta offset values associated with one transport block (TB) and two TBs;
receiving, from the network node, downlink control information (DCI) or a radio resource control (RRC) message scheduling a physical uplink shared channel (PUSCH) associated with one TB or two TBs; and
transmitting uplink control information (UCI), via a quantity of resource elements (REs), on the PUSCH associated with the one TB or the two TBs based on receiving the DCI or the RRC message, the quantity of REs determined based on a beta offset value from a set of beta offset values of the plurality of sets of beta offset values, the set of beta offset values selected from the plurality of sets of beta offset values based on whether the UCI is transmitted on the PUSCH associated with the one TB or the two TBs.

2. The method of claim 1, in which the signaling indicating the plurality of sets of beta offset values is a semi-static indication.

3. The method of claim 2, in which:
the plurality of sets of beta offset values includes a first set of beta offset values and a second set of beta offset values;
the set of beta offset values corresponds to the first set of beta offset values based on the UCI being transmitted on the PUSCH associated with the one TB; and
the set of beta offset values corresponds to the second set of beta offset values based on the UCI being transmitted on the PUSCH associated with the two TBs.

4. The method of claim 1, in which:
the plurality of sets of beta offset values includes a first group of sets of beta offset values and a second group of sets of beta offset values;
the set of beta offset values corresponds to one set of beta offset values from the first group of sets of beta offset values based on the UCI being transmitted on the PUSCH associated with the one TB; and
the set of beta offset values corresponds to one set of beta offset values from the second group of sets of beta offset values based on the UCI being transmitted on the PUSCH with the two TBs.

5. The method of claim 4, in which:
each set of beta offset values in the first group of sets of beta offset values and the second group of sets of beta offset values is associated with a different codepoint; and
the set of beta offset values corresponds to a codepoint indicated via the DCI.

6. The method of claim 1, in which:
each set of beta offset values of the plurality of sets of beta offset values includes multiple beta offset values; and
each beta offset value of the multiple beta offset values corresponds to one or both of a UCI type or a payload.

7. The method of claim 1, in which the signaling is RRC signaling.

8. The method of claim 1, in which the UCI includes hybrid automatic repeat request (HARQ) feedback, channel state information (CSI), or configured grant uplink control information (CG-UCI).

9. An apparatus for wireless communications at a user equipment (UE), comprising:
a processor; and
a memory coupled with the processor and storing instructions operable, when executed by the processor, to cause the apparatus to:
receive, from a network node, signaling indicating a plurality of sets of beta offset values associated with one transport block (TB) and two TBs;
receive, from the network node, downlink control information (DCI) or a radio resource control (RRC) message scheduling a physical uplink shared channel (PUSCH) associated with one TB or two TBs; and
transmit uplink control information (UCI), via a quantity of resource elements (REs), on the PUSCH associated with the one TB or the two TBs based on receiving the DCI or the RRC message, the quantity of REs determined based on a beta offset value from a set of beta offset values of the plurality of sets of beta offset values, the set of beta offset values selected from the plurality of sets of beta offset values based on whether the UCI is transmitted on the PUSCH associated with the one TB or the two TBs.

10. The apparatus of claim 9, in which the signaling indicating the plurality of sets of beta offset values is a semi-static indication.

11. The apparatus of claim 10, in which:
the plurality of sets of beta offset values includes a first set of beta offset values and a second set of beta offset values;
the set of beta offset values corresponds to the first set of beta offset values based on the UCI being transmitted on the PUSCH associated with the one TB; and
the set of beta offset values corresponds to the second set of beta offset values based on the UCI being transmitted on the PUSCH associated with the two TBs.

12. The apparatus of claim 9, in which:
the plurality of sets of beta offset values includes a first group of sets of beta offset values and a second group of sets of beta offset values;
the set of beta offset values corresponds to one set of beta offset values from the first group of sets of beta offset values based on the UCI being transmitted on the PUSCH associated with the one TB; and
the set of beta offset values corresponds to one set of beta offset values from the second group of sets of beta offset values based on the UCI being transmitted on the PUSCH with the two TBs.

13. The apparatus of claim 12, in which:
each set of beta offset values in the first group of sets of beta offset values and the second group of sets of beta offset values is associated with a different codepoint; and
the set of beta offset values corresponds to a codepoint indicated via the DCI.

14. The apparatus of claim 9, in which:
each set of beta offset values of the plurality of sets of beta offset values includes multiple beta offset values; and
each beta offset value of the multiple beta offset values corresponds to one or both of a UCI type or a payload.

15. The apparatus of claim 9, in which the signaling is RRC signaling.

16. The apparatus of claim 9, in which the UCI includes hybrid automatic repeat request (HARQ) feedback, channel state information (CSI), or configured grant uplink control information (CG-UCI).

17. A method for wireless communication at a user equipment (UE), comprising:
receiving, from a network node, signaling indicating a plurality of sets of beta offset values associated with two transport blocks (TBs);
receiving, from the network node, downlink control information (DCI) or a radio resource control (RRC) message scheduling a physical uplink shared channel (PUSCH) associated with two TBs; and
transmitting first uplink control information (UCI), via a quantity of first resource elements (REs), on the PUSCH associated within a first TB of the two TBs based on receiving the DCI or the RRC message, the quantity of first REs determined based on a beta offset value from a set of beta offset values of the plurality of sets of beta offset values, the set of beta offset values selected based on whether second UCI is multiplexed on second REs within a second TB of the two TBs, the first REs corresponding to the second REs.

18. The method of claim 17, in which the signaling indicating the plurality of sets of beta offset values is a semi-static indication.

19. The method of claim 18, in which:
the plurality of sets of beta offset values includes a first set of beta offset values and a second set of beta offset values;
the set of beta offset values corresponds to the first set of beta offset values based on no UCI being multiplexed on the second REs; and
the set of beta offset values corresponds to the second set of beta offset values based on the second UCI being multiplexed on the second REs.

20. The method of claim 17, in which:
the plurality of sets of beta offset values includes a first group of sets of beta offset values and a second group of sets of beta offset values;
the set of beta offset values corresponds to one set of beta offset values from the first group of sets of beta offset values based on no UCI being multiplexed on the second REs; and
the set of beta offset values corresponds to one set of beta offset values from the second group of sets of beta offset values based on the second UCI being multiplexed on the second REs.

21. The method of claim 20, in which:
each respective set of beta offset values in the first group of sets of beta offset values and the second group of sets of beta offset values is associated with a different codepoint; and
the set of beta offset values corresponds to a codepoint indicated via the DCI.

22. The method of claim 17, in which:
each set of beta offset values of the plurality of sets of beta offset values includes multiple beta offset values; and
each beta offset value of the multiple beta offset values corresponds to one or both of a UCI type or a payload.

23. The method of claim 17, in which the signaling is RRC signaling.

24. An apparatus for wireless communications at a user equipment (UE), comprising:
a processor; and
a memory coupled with the processor and storing instructions operable, when executed by the processor, to cause the apparatus to:
receive, from a network node, signaling indicating a plurality of sets of beta offset values associated with two transport blocks (TBs);
receive, from the network node, downlink control information (DCI) or a radio resource control (RRC) message scheduling a physical uplink shared channel (PUSCH) associated with two TBs; and
transmit first uplink control information (UCI), via a quantity of first resource elements (REs), on the PUSCH associated within a first TB of the two TBs based on receiving the DCI or the RRC message, the quantity of first REs determined based on a beta offset value from a set of beta offset values of the plurality of sets of beta offset values, the set of beta offset values selected based on whether second UCI is multiplexed on second REs within a second TB of the two TBs, the first REs corresponding to the second REs.

25. The apparatus of claim 24, in which the signaling indicating the plurality of sets of beta offset values is a semi-static indication.

26. The apparatus of claim 25, in which:
the plurality of sets of beta offset values includes a first set of beta offset values and a second set of beta offset values;
the set of beta offset values corresponds to the first set of beta offset values based on no UCI being multiplexed on the second REs; and
the set of beta offset values corresponds to the second set of beta offset values based on the second UCI being multiplexed on the second REs.

27. The apparatus of claim 24, in which:
the plurality of sets of beta offset values includes a first group of sets of beta offset values and a second group of sets of beta offset values;
the set of beta offset values corresponds to one set of beta offset values from the first group of sets of beta offset values based on no UCI being multiplexed on the second REs; and
the set of beta offset values corresponds to one set of beta offset values from the second group of sets of beta offset values based on the second UCI being multiplexed on the second REs.

28. The apparatus of claim 27, in which:
each respective set of beta offset values in the first group of sets of beta offset values and the second group of sets of beta offset values is associated with a different codepoint; and
the set of beta offset values corresponds to a codepoint indicated via the DCI.

29. The apparatus of claim 24, in which:
each set of beta offset values of the plurality of sets of beta offset values includes multiple beta offset values; and
each beta offset value of the multiple beta offset values corresponds to one or both of a UCI type or a payload.

30. The apparatus of claim 24, in which the signaling is RRC signaling.
